(19) United States
(12) Patent Application Publication
(10) Pub. No.: US 2012/0079074 A1
(43) Pub. Date: Mar. 29, 2012

(54) NETWORK COMMUNICATION SYSTEM

(75) Inventor: James Joseph Anthony Mccormack, Eindhoven (NL)

(73) Assignee: KONINKLIJKE PHILIPS ELECTRONICS N.V., EINDHOVEN (NL)

(21) Appl. No.: 13/377,330

(22) PCT Filed: Jun. 8, 2010
(86) PCT No.: PCT/IB10/52539

§ 371 Date: Dec. 9, 2011

(30) Foreign Application Priority Data
Jun. 9, 2009 (EP) 09162251.4

(51) Int. Cl. G06F 15/16

(52) U.S. Cl. 709/217

(57) ABSTRACT

A network communication system (2) comprises: a controlled network device (11) comprising a communication facility (16) for receiving a command signal (Sc); at least one remote control (20) for controlling at least one of the network devices (11), the remote control comprising a communication facility (26) for receiving and transmitting signals; one coordinator (40) comprising a communication facility (46) for receiving and transmitting signals, and a network definition memory (47) containing network definition information defining the network and the relationship between network components. The remote control comprises a backup memory (27) containing a backup copy of the network definition information. The remote control is capable of operating in a restoration mode in which the remote control transmits a restoration signal (SR) containing the network definition information from the backup memory. The coordinator is responsive to the restoration signal by storing the received network definition information into its network definition memory.

### FIELD OF THE INVENTION

The present invention relates in general to a communication system having a network structure. In a particular example, the invention may relate to a system for controlling a plurality of light sources, and the invention will be specifically explained with reference to this example, but it is noted that the invention is not limited to this example. Particularly, the network may comprise multiple household appliances of different nature, for instance lighting devices, heating devices, televisions, etc; more generally, any electrically powered appliance, either powered from mains or from a battery, or from a so-called energy harvesting source (batteryless).

### BACKGROUND OF THE INVENTION

In a particular example, the invention relates to an illumination system comprising a plurality of lamps. Each lamp is provided with a network device capable of switching the corresponding lamp ON or OFF, and possibly capable of dimming the lamp. In the case of an armature with multi-color lamps, the lamps can be ordered to make a certain desirable mix color. A user-operated remote control is a network component capable of issuing command signals to the network devices over a communication path that may be wired but preferably is wireless; a preferred way of communication is via RF signals. Thus, the user can remotely operate his illumination system without needing to operate individual switches located with the individual lamps. Further, the system does not require a new infrastructure: an existing lightbulb may simply be replaced by a new lightbulb having the associated network device. However, it is also possible that the network device is associated with an armature.

In the following discussion, for sake of convenience, reference will be made to a “lamp” in cases where actually the network device of such lamp is intended, as should be clear to a person skilled in the art.

In order to be able to operate a plurality of lamps individually, it is necessary that the lamps can be distinguished from each other. Therefore, each lamp has a unique ID code and/or (short) address code, and the command signal issued by the remote control contains an instruction part as well as a part indicating the addressee, i.e. the lamp for which the instruction is intended; the instruction part tells this lamp what it is expected to do.

The command signal may also contain a request for acknowledgement; in that case, apart from receiving and obeying the instruction, the network device also sends an acknowledgement message to the remote control, so that the remote control knows that its command signal has been received by the addressee network device. If such acknowledgement message is not received quickly enough, the remote control will automatically resend the command signal, without the user needing to actuate the corresponding command button again.

The system further comprises a memory containing network definition information. This memory will be indicated as network definition memory. The network definition information comprises, inter alia, a list of ID codes of network devices and a list of ID codes of corresponding remote control devices. It is noted that there may be more network devices in the neighborhood taking part in the communication and therefore per definition being part of the communication network, but if a network device is not included in the network definition information (i.e. it is not on the list), it cannot be addressed and therefore not operated by the remote control. Further, it is noted that there may be more remote control devices in the neighborhood, but if a remote control is not included in the network definition information (i.e. it is not on the list), its command signals will not be accepted or obeyed.

Further, the network definition information may comprise a table defining which network device (ID code) is associated with which command button. It is possible that the remote control has command buttons associated with individual lamps. However, it is preferred that one command button is capable of operating a group of lamps simultaneously. In that case, the network definition information may comprise, for each command button, a list of network devices (ID codes) associated with that particular command button, or, alternatively, a list defining which network devices are member of which group as well as a table defining which group is associated with which command button.

The network is not static. It is possible that lamps are added or removed, or that the group assignment of a lamp is changed. Thus, there is functionality allowing the user to amend the network definition memory. The combination of network definition memory and the amendment functionality will be indicated as “coordinating means”.

Especially in cases where the network comprises only one remote control device, it may be that the coordinating means are integrated with the remote control device. However, and especially in cases where the network comprises multiple remote controls, either all intended for controlling all lamps or different remote controls intended for controlling different lamps or different groups of lamps, it may be that the coordinating means are implemented as a separate device, which will be indicated by the phrase “coordinator”. An advantage of a separate coordinator device lies in the fact that the remote control is preferably implemented as a light-weight battery operated device while the coordinator is preferably provided with constant power from mains so that its settings are not lost when the batteries run empty.

A particularly suitable communication protocol for implementing the present invention is Zigbee. Since Zigbee is known per se, as it is an open source standard, a detailed description of Zigbee is omitted here.

### SUMMARY OF THE INVENTION

Put in other words, the network comprises one network component with network definition information, controlling and coordinating all communication traffic between the other network components, either implemented as a separate coordinator or integrated in a remote control component. For sake of convenience, the following discussion will assume that there is a separate coordinator component, but the gist of the invention is also applicable in the case of the coordinating functionality being integrated in a remote control component.

A problem that may occur in practice is that the coordinator fails. As a result, the network communication fails: what the user perceives is that the lamps can no longer be controlled by the remote control. The user will say that the network is broken.

WO 2008/084356, the full contents of which are incorporated here by reference, discloses a network comprising a coordinator, one or more remote control devices, and one or more controlled lamps. The publication mentions that it is possible to add network components to the existing network, for which purpose such network component is capable of operating in an enlistment mode. The publication describes an inventive way of establishing the network, i.e. establishing the network definition information in the coordinator, in an initial phase when the network components are brand new. In a network in accordance with this publication, when the coordinator fails, the user has to replace the coordinator by a new coordinator, which is added to the network by being operated in its enlistment mode. In that case, all other network devices have to communicate to the new coordinator in order to enable the coordinator to collect all required network definition information. This requires user action: the user has to reset each device and rebuild the network with the new coordinator.

WO 2004/056157, the full contents of which are incorporated here by reference, discloses a network comprising a plurality of lamp ballasts and remote control devices, wherein the network has a master-slave architecture. The coordinating functionality is implemented in one of the ballasts, which is indicated as the master. The other ballasts are indicated as slaves. This publication addresses the problem that the master may fail. As a solution, the publication provides that each slave ballast is a backup master. When the master fails, the first slave that is confronted with this fact becomes the new master. This approach requires that all network definition information is present in each ballast, and that some kind of code is established as to which of the ballasts is the master.

In the above earlier art, problems may arise if the take-over from old coordinator to new coordinator is not done perfectly due to for instance RF communication problems. Such problems are not easy to recognize nor to understand for a normal user, but the system itself can not correct so the user is expected to take corrective action, which may lead to frustration.

An object of the present invention is to provide a more simple and less expensive solution, which is more robust than the earlier art, i.e. more fail-safe.

According to the present invention, at least one remote control is provided with a back-up memory containing all network definition information, and this remote control is capable of operating in a restoration mode in which it transmits this network definition information to a new coordinator. When the coordinator fails, the user only needs to provide a new one, to plug it in, and to give a restoration command to the remote control (for instance by pressing an appropriate button or combination of buttons), so that all network definition information is copied to the new coordinator, after which the system operates as before.

Further advantageous elaborations are mentioned in the dependent claims.

### BRIEF DESCRIPTION OF THE DRAWINGS

These and other aspects, features and advantages of the present invention will be further explained by the following description of one or more preferred embodiments with reference to the drawings, in which same reference numerals indicate same or similar parts, and in which:

FIG. 1 schematically shows a light bulb with a network device;

FIG. 2 schematically shows a communication system;

FIG. 3 schematically illustrates a control signal;

FIG. 4 is a table schematically illustrating network definition information.

### DETAILED DESCRIPTION OF THE INVENTION

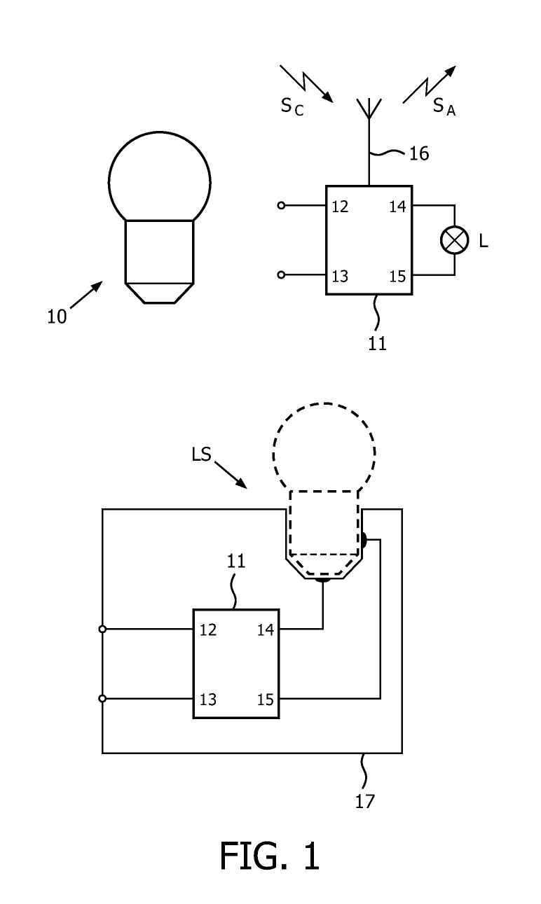

By way of example of an appliance in accordance with the present invention, FIG. 1 schematically shows a light bulb 10. The outer appearance of the light bulb is quite common, but internally the light bulb 10 comprises a network device 11 having terminals 12, 13 connected to the lamp contacts for receiving power, and having output terminals 14, 15 connected to the actual light-generating element of the light bulb, e.g. a spiral L. Alternatively, instead of an incandescent light source, other types of light sources are possible, for instance a LED or a gas discharge lamp, in which case the output terminals 14, may be connected to a corresponding lamp driver. The network device 11 further has a communication facility, indicated by an antenna 16, via which the network device 11 is capable of receiving a command signal S_{C} and issuing an acknowledgement signal S_{A}.

FIG. 1 also schematically shows an alternative appliance in accordance with the present invention, i.e. an armature 17 having a lamp socket LS for receiving a replaceable lamp L, the armature 17 comprising a network device 11 having its output terminals 14, 15 connected to the socket contacts for contacting the lamp contacts.

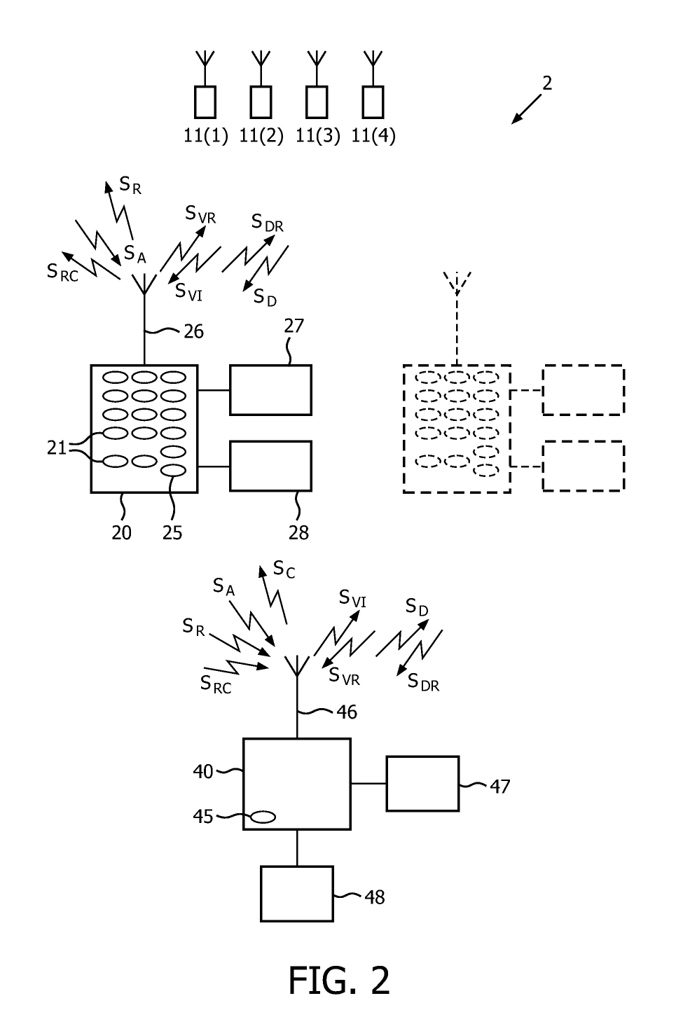

FIG. 2 schematically shows a network communication system 2, comprising a plurality of remote controlled network devices 11. In FIG. 2, for sake of simplicity, only four of such network devices 11 are shown, supplemented by an index 1, 2, 3, 4 between brackets for mutual distinction; however, it should be clear that the number of network devices may be less or more than four. It is noted that the invention particularly relates to an illumination system comprising a plurality of lamps 10 and/or armatures 17, each provided with a corresponding one of the network devices 11(i).

The communication system 2 further comprises a user-operated remote control 20, also having a communication facility, indicated by an antenna 26, via which the remote control 20 is capable of issuing a command signal S_{RC} and receiving an acknowledgement signal S_{A}. The remote control 20 has user input means, typically control keys or buttons, indicated at 21. It is noted that the communication system 2 may comprise two or more remote control devices: a second remote control is shown in dotted lines.

The communication system 2 further comprises a coordinator 40, typically implemented as a suitably programmed microcomputer or the like. The coordinator 40 also has a communication facility, indicated by an antenna 46, via which the coordinator 40 is capable of receiving the command signals S_{RC} from the remote control 20 and the acknowledgement signals S_{A} from the controlled network devices 11.

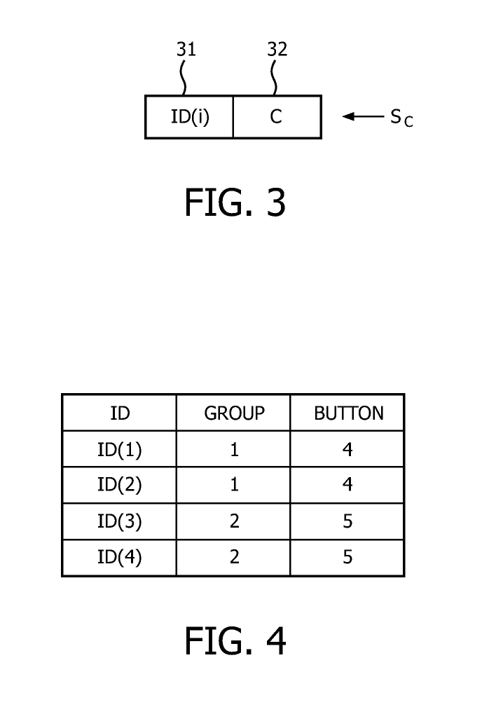

In order to be individually addressable, each network device 11 has a unique ID code, indicated as ID(i). FIG. 3 schematically illustrates that the command signal S_{C} comprises a data part 31 containing the ID code ID(i) of the network device 11(i) addressed, and a command part 32 containing the actual command, for instance “switch ON” or “switch OFF”. Other methods for indicating which network device or group of network devices are addressed are also applicable. Thus, for being able to control a certain network device 11(i), the remote control 20 must know the ID code ID(i) of this network device 11(i).

On the other hand, a network device 11(i) receiving a command signal S_{C} containing its ID code ID(i) must check whether this command signal S_{C} originates from a “stranger” or from a remote control 20 that is part of the network. Thus, for being able to obey the command signal S_{C}, the network device 11(i) must know the ID code of the remote control 20.

The coordinator 40 is provided with a network definition memory 47, comprising, among others, a list of ID codes of network components belonging to the network, and a relationship between remote control buttons and ID codes. Further, the network devices may be arranged in groups, and the network definition memory 47 also contains the group allocation information. Suitably, the information in the network definition memory 47 is arranged as a table. FIG. 4 gives an example of such table. The figure shows that the network comprises four network devices with ID codes ID(1) to ID(4), that network devices ID(1) and ID(2) belong to group 1 and are associated with button 4, and that network devices ID(3) and ID(4) belong to group 2 and are associated with button 5. It is also possible that there is no separate group information, because the association with a certain button already implies a group allocation. It is also possible that there is a table associating network devices with groups, and that there is a separate table associating groups with buttons.

By operating the suitable button 21, the user can thus remotely operate the network devices 11, either individually or in groups.

Assume that the user wishes to switch ON a particular lamp. To do so, he actuates the corresponding button 21 of the remote control 20, which sends a command signal S_{RC} that is received by the coordinator 40. The coordinator 40 processes the information in the command signal S_{RC}, consults the network definition memory 47, and issues an appropriate command signal S_{RC} containing the ID code of the intended network device 11. This command signal S_{RC} is received by all network devices 11, but only the intended network device responds by switching ON its associated lamp and returning an acknowledgement signal S_{A}. This acknowledgement signal S_{A} is received by the coordinator 40 and/or by the remote control 20.

Assume that the coordinator 40 fails. In that case, the coordinator 40 is not capable of processing the command signal S_{RC} and issuing the command signal S_{RC}: the user will notice that the intended network device (or rather its associated lamp) does not respond by switching ON. To remedy this, the user may purchase a replacement coordinator, but this replacement coordinator does (normally) not have any network definition information in its network definition memory, so this replacement coordinator is also not capable of processing the command signal S_{RC} and issuing the command signal S_{RC}. To restore the network, the user would have to rebuild the network, which is a tedious and user-unfriendly task.

To overcome this problem, a first aspect of the present invention involves the remote control 20 comprising a backup memory 27. This backup memory 27 contains the same network definition information as the network definition memory 47, typically as a straight copy of the network definition information. A second aspect of the present invention involves the remote control 20 comprising a restoration button 25 which, when actuated by the user, causes the remote control to enter a restoration mode. Actuation by the user may, in order to avoid possible unintentional actuation, involve some kind of code, for instance the need to press two buttons simultaneously, or the need to press one or more buttons for a certain minimum duration of time. In the restoration mode, the remote control 20 sends a restoration signal S_{R}, which contains all network definition information, possibly preceded by a specific restoration code.

It is noted that the gist of the present invention is already implemented if one remote control 20 is implemented as explained above. However, in case of a system comprising two or more remote controls, it would be preferred if each remote control 20 would be implemented as explained above.

A third aspect of the present invention involves the replacement coordinator (which may have the same design as the coordinator 40 and which will therefore be indicated by the same reference numeral) to be responsive to the restoration signal S_{R} by accepting the received network definition information contained in the restoration signal S_{R} and store this information into its network definition memory 47. After having stored this received network definition information into its network definition memory 47, the replacement coordinator 40 will function in the same way as the “old” coordinator 40. The user does not need to redefine the network.

A coordinator 40 may be designed to fill its network definition memory 47 with (or to replace the contents of its network definition memory 47 by) the received network definition information contained in the restoration signal S_{R} always when receiving such restoration signal S_{R}. However, it is preferred that the coordinator 40 is capable of operating in a specific initiation mode, and that the coordinator 40 is only responsive to the restoration signal S_{R} when operating in this initiation mode. For entering the initiation mode, the coordinator 40 may comprise a user-operable button 45. Actuation by the user may, in order to avoid possible unintentional actuation, for instance involve the need to press this button for a certain minimum duration of time, or the need to press this button simultaneously with powerup. Alternatively or additionally, it is possible that the coordinator 40 is designed to automatically enter the initiation mode on power-up for the very first time, i.e. as described in WO 2008/084356.

In the following, several methods will be described for keeping the backup network definition information in the backup memory 27 up to date. If this information is not quite up to date, the gist of the present invention is still applicable because the replacement coordinator 40 still allows the user to have a working network, but it may be that the user will find that this network actually corresponds to an older version.

Updating the backup network definition information in the backup memory 27 involves the coordinator 40 transmitting the network definition information from its network definition memory 47, and the remote control 20 receiving this network definition information and storing it into its backup memory 27. For briefness, this process will also be indicated as downloading the network definition information from the coordinator 40 to the remote control 20. Likewise, the communication in the opposite direction (in restoration) will be indicated as uploading the network definition information from the remote control 20 to the coordinator 40. It is noted that the precise protocols used for downloading (and the same applies to uploading) are not essential, as should be clear to person skilled in the art, so that these protocols need not to be explained here. It is important, however, to realize that the process of downloading (and the same applies to uploading) involves two devices cooperating with each other: one sending and one receiving.

One method is that the downloading process is started on a regular time basis, controlled by a clock device, for instance every hour. Such clock device may be accommodated in the coordinator 40. While such approach will assure that the information is kept up to date, at least never older than the refresh rate (in this example: one hour), it is evident that this approach will involve many unnecessary data transmissions, unnecessary because the network definition information has not changed since the last download, so the energy consumption of the battery-powered remote control(s) is unnecessarily high. Other, more efficient methods may be achieved if downloading is only performed when the network definition information has actually changed or at least may have changed.

In order to allow such more efficient method, it is preferred that the coordinator 40 is provided with a network version counter 48. This counter 48 is a memory containing a version number, i.e. a value that is incremented each and every time that any change is made to the network configuration, i.e. the network definition information in the network definition memory 47. Suitably, but not necessarily, this version number is an integer that is always incremented by one. Further, the remote control 20 comprises a backup version memory 28 containing a copy of the version number. The downloading procedure involves copying the version number from the network version counter 48 to the backup version memory 28, and the uploading procedure involves copying the version number from the backup version memory 28 to the network version counter 48.

In such embodiment, the remote control 20 is preferably programmed to do a version verification check in response to certain predefined check trigger events, as will be explained later. The version verification check involves a first step in which the remote control 20 sends a version request signal S_{VR} to the coordinator 40. In a second step, the coordinator 40 responds by transmitting to the remote control 20 a version information signal S_{VI} containing the version number from the network version counter 48. In a third step, the remote control 20 compares the received information with the contents of its backup version memory 28. If it appears that the received version number is equal to the version number of the network backup in its backup version memory 28, no new download is necessary. If it appears that the received version number is higher than the version number of the network backup in its backup version memory 28, the remote control 20 decides to initiate the download procedure.

In a preferred embodiment, a check trigger event may be the activation of the remote control 20. In other words, the remote control 20 will always perform a version check on activation. Activation can be done by a user action, such as actuation of one of the control buttons 21, or by a timer. This embodiment ensures that an active remote control will always carry the most resent backup version.

In another embodiment, a check trigger event may be the remote control 20 going to enter a sleep mode, for instance after having been inactive for a certain time. This embodiment ensures that an inactive remote control will always carry the backup version that was most resent when it went to sleep.

In yet another embodiment, a check trigger event may be the user actuating a control function that may change the network definition. Such control function may for instance be the allocation of a control button to a network device.

It should be clear that the above-described embodiments can be combined.

In the above embodiments, the remote control 20 verifies whether it has the current network definition information, and if it finds this not to be the case, it downloads the current network definition information. Specifically, the remote control send a download request signal S_{DR} to the coordinator 40, and the coordinator is responsive to receiving the download request signal S_{DR} by transmitting a download signal S_{D} containing the network definition information from its network definition memory 47. Thus, it is always the remote control that starts a verification, because the remote controls do not know whether the network definition information has changed. On the other hand, the coordinator does know when network definition information is changed. Therefore, an embodiment is possible where the download procedure is initiated by the coordinator in response of a change of the network definition information. At the moment when the coordinator does initiate a download procedure, it may be that one or more of the remote controls are in sleep mode and do not respond. This may be solved if the coordinator is capable of sending a wake-up signal and the remote controls are responsive to such signal by going from the sleep mode to an active state. Alternatively, it may be solved if the coordinator receives a download confirmation signal from the remote controls after completion of the download, and the coordinator comprises a memory with a table containing a list of remote controls of the network and for each remote control the version number of the latest download. Whenever a remote control is activated, the coordinator may consult this list to see whether the remote control is up to date as far as the backup information is concerned, by comparing the corresponding version number from the list with the information in the network version counter 48: if the remote control is not up to date, the coordinator can initiate the download procedure with this now active remote control.

From the above it should be clear that downloading can be initiated by either the coordinator or the remote control, or both, and in both cases the downloading procedure can be performed only when necessary thus avoiding unnecessary energy consumption.

Summarizing, the present invention provides a network communication system 2 comprising:

a controlled network device 11 comprising a communication facility 16 for receiving a command signal Sc;

at least one remote control 20 for controlling at least one of the network devices 11, the remote control comprising a communication facility 26 for receiving and transmitting signals;

one coordinator 40 comprising a communication facility 46 for receiving and transmitting signals, and a network definition memory 47 containing network definition information defining the network and the relationship between network components. The remote control comprises a backup memory 27 containing a backup copy of the network definition information. The remote control is capable of operating in a restoration mode in which the remote control transmits a restoration signal S_{R} containing the network definition information from the backup memory. The coordinator is responsive to the restoration signal by storing the received network definition information into its network definition memory.

After the user has installed a new coordinator, the network recovery takes place automatically and is transparent to the user. There is no need to set up the network control configuration again.

While the invention has been illustrated and described in detail in the drawings and foregoing description, it should be clear to a person skilled in the art that such illustration and description are to be considered illustrative or exemplary and not restrictive. The invention is not limited to the disclosed embodiments; rather, several variations and modifications are possible within the protective scope of the invention as defined in the appending claims.

For instance, the communication system may be implemented in a system comprising devices different than lamps. Even a lighting system may comprise lighting devices different from lamps, such as armatures, transformers, etc, provided with network devices.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measures cannot be used to advantage. Any reference signs in the claims should not be construed as limiting the scope.

In the above, the present invention has been explained with reference to block diagrams, which illustrate functional blocks of the device according to the present invention. It is to be understood that one or more of these functional blocks may be implemented in hardware, where the function of such functional block is performed by individual hardware components, but it is also possible that one or more of these functional blocks are implemented in software, so that the function of such functional block is performed by one or more program lines of a computer program or a programmable device such as a microprocessor, microremote control, digital signal processor, etc.

1. Network communication system, comprising:
at least one controlled network device, having input terminals for connection to a power source and having output terminals for providing output power, the device further comprising a communication facility for receiving a command signal, wherein the controlled network device is designed to switch its output power ON or OFF or to dim its output power in response to a received command signal;
at least one remote control for controlling at least one of the network devices, the remote control comprising a communication facility for receiving and transmitting signals, including command signals for the controlled network device;
one coordinator comprising a communication facility for receiving and transmitting signals, the coordinator being provided with a network definition memory containing network definition information defining the network and the relationship between network components;
wherein the remote control comprises a backup memory containing a backup copy of the network definition information;
wherein the remote control is capable of operating in a restoration mode in which the remote control transmits a restoration signal containing the network definition information from the backup memory;
and wherein the coordinator is responsive to the restoration signal by storing the received network definition information into its network definition memory.

2. Network communication system according to claim 1, wherein the remote control comprises a user-actuable restoration button, and wherein the remote control is responsive to user-actuation of the restoration button by entering the restoration mode.

3. Network communication system according to claim 1, comprising multiple remote controls, wherein each remote control is capable of operating in said restoration mode.

4. Network communication system according to claim 1, wherein the coordinator is capable of operating in an initiation mode, and wherein the coordinator is responsive to the restoration signal only when operating in this initiation mode.

5. Network communication system according to claim 4, wherein the coordinator comprises a user-operable initiation button, and wherein the coordinator is responsive to user-actuation of the initiation button by entering the initiation mode.

6. Network communication system according to claim 4, wherein the coordinator is designed to automatically enter the initiation mode on initial power-up.

7. Network communication system according to claim 1, wherein the coordinator further comprises a network version counter containing a version number of the network definition information in the network definition memory;
wherein the coordinator is designed to increment the version number each and every time that any change is made to the network definition information in the network definition memory;
wherein the remote control comprises a backup version memory containing a backup copy of the version number;
wherein the restoration signal sent by the remote control when operating in the restoration mode also contains the backup version number from the backup version memory;
and wherein the coordinator also stores the received backup copy of the version number into its network version counter.

8. Network communication system according to claim 1, wherein the coordinator is capable of transmitting a download signal containing the network definition information from its network definition memory, and wherein the remote control is capable of receiving this download signal and storing the network definition information contained therein as backup into its backup memory.

9. Network communication system according to claim 7, wherein the remote control is capable of verifying that its backup memory contains the current network definition information;
wherein the remote control, if the verification result indicates that its backup network definition information is outdated, sends a download request signal to the coordinator;
wherein the coordinator is responsive to receiving the download request signal by transmitting a download signal containing the network definition information from its network definition memory, and wherein the remote control is capable of receiving this download signal and storing the network definition information contained therein as backup into its backup memory.

10. Network communication system according to claim 9, wherein the remote control is designed to send to the coordinator version request signal;
wherein the coordinator is responsive to receiving the version request signal by transmitting to the remote control a version information signal containing the version number from the network version counter;
wherein the remote control is designed to compare the received information with the contents of its backup version memory and, if it appears that the received version number is higher than the version number of the network backup in its backup version memory, to send the download request signal.

11. Network communication system according to claim 10, wherein the remote control is designed to send the version request signal each time when the remote control is activated by a user or by a timer;
and/or wherein the remote control is designed to send the version request signal each time when the remote control is going to enter a sleep mode;
and/or wherein the remote control is designed to send the version request signal each time when the user actuates a control function capable of changing the network definition.

12. Illumination system comprising a plurality of lamps and/or armatures, the system further comprising a network communication system according to any of the previous claims, wherein at least on lamp and/or at least one armatures is provided with a controlled network device.

13. Remote control for use in a network communication system according to claim 1, the remote control comprising a communication facility for receiving and transmitting signals, including command signals for the controlled network device;
wherein the remote control comprises a backup memory containing a backup copy of the network definition information;
wherein the remote control is capable of operating in a restoration mode in which the remote control transmits a restoration signal containing the network definition information from the backup memory.

14. Remote control according to claim 13, wherein the remote control comprises a backup version memory containing a backup copy of the network version number;
wherein the remote control is designed to transmit a version request signal;
wherein the remote control is designed to receive a version information signal containing the version number of the network, to compare the received information with the contents of its backup version memory and, if it appears that the received version number is higher than the version number of the network backup in its backup version memory, to transmit a download request signal;
and wherein the remote control is capable of receiving a download signal and storing the network definition information contained therein as backup into its backup memory.

15-16. (canceled)
